(19) United States
(12) Patent Application Publication
(10) Pub. No.: US 2017/0352036 A1
(43) Pub. Date: Dec. 7, 2017

(54) METHODS AND APPARATUS FOR AUTHORIZING A TRANSACTION

(71) Applicant: MasterCard International Incorporated, Purchase, NY (US)

(72) Inventor: Arunmurthy Gurunathan, Pune (IN)

(21) Appl. No.: 15/610,880

(22) Filed: Jun. 1, 2017

(30) Foreign Application Priority Data
Jun. 6, 2016 (SG) 10201604590X

(51) Int. Cl. G06Q 20/40; G06Q 20/34

(52) U.S. Cl. CPC G06Q 20/401; G06Q 20/34

(57) ABSTRACT

A computer implemented method of processing an authorization request for a transaction in a first territory associated with a payment card issued in a second territory is disclosed. The method comprises receiving, at a server of a payment network, a transaction authorization request, the transaction authorization request comprising an indication of a payment card identifier of a payment card associated with the transaction; determining, using the payment card identifier, a local nominated issuer, the local nominated issuer being an issuing authority within the first territory authorized to process authorization requests associated with the payment card; routing the transaction authorization request to a server of the local nominated issuer; and receiving a transaction authorization response from the server of the local nominated issuer.

### TECHNICAL FIELD AND BACKGROUND

This application is a U.S. National Stage filing under 35 U.S.C. §119, based on and claiming benefits of and priority to SG Patent Application No. 10201604590X filed Jun. 6, 2016.

The present disclosure relates to systems and methods for authorizing a transaction. In particular, it provides methods and systems for authorizing a transaction in a first country or territory associated with a payment card issued in a second country or territory.

Payment cards such as credit cards are issued locally to a particular country and generally when transactions take place outside the country in which the card was issued, the card issuer in the origin country authorizes the transaction. The process in which the authorization by the card issuer takes place in a different country from the transaction may be termed ‘cross border authorization’. This process can result in a large amount of data exchange between countries and there are often high fees associated with currency conversion. Local authorization can be accomplished faster than cross border authorization, therefore the transaction time will be reduced, an advantage for the merchant and the card holder. Further, if there is any interruption in the data communication between the countries, the transaction might be declined even though the cardholder has not reached his credit limit. Local authorization will reduce the risk of these unjustified declined transactions. One alternative to cross border authorization is the use of pre-paid payment cards and multicurrency payment cards. However, such pre-paid cards must be pre-loaded with the currency of the destination country. Unutilized funds in respective currencies have to be converted back to local currency once the travel is complete. Thus, cardholders may be charged for conversion twice.

### SUMMARY

In general terms, the present disclosure proposes a method of processing transaction authorization requests when a cardholder makes a transaction outside the country or territory in which their payment card was issued. Instead of the transaction authorization request being send to the card issuer in the territory in which the payment card was issued, the transaction authorization request is forwarded to a local nominated issuer in the territory in which the transaction takes place. This process allows local authorization to be carried out even when a transaction take places outside the country in which the payment card was issued.

According to a first aspect of the present invention, there is provided a computer implemented method of processing an authorization request for a transaction in a first territory associated with a payment card issued in a second territory. The method comprises receiving, at a server of a payment network, a transaction authorization request, the transaction authorization request comprising an indication of a payment card identifier of a payment card associated with the transaction; determining, using the payment card identifier, a local nominated issuer, the local nominated issuer being an issuing authority within the first territory authorized to process authorization requests associated with the payment card; routing the transaction authorization request to a server of the local nominated issuer; and receiving a transaction authorization response from the server of the local nominated issuer.

In an embodiment determining using the payment card identifier, a local nominated issuer comprises identifying an entry in a routing table corresponding to the payment card identifier.

According to a second aspect of the present invention there is provided a computer implemented method of processing an authorization request for a transaction in a first territory associated with a payment card issued in a second territory. The method comprises receiving, at a server of a local nominated issuer, a transaction authorization request, the local nominated issuer being an issuing authority within the first territory authorized to process authorization requests associated with the payment card, the transaction authorization request comprising an indication of a payment card identifier of a payment card associated with the transaction and a transaction amount associated with the transaction; looking up a credit limit associated with the payment card on a payment card information server; comparing the transaction amount with the credit limit; and generating a transaction authorization response based on a result of comparing the transaction amount with the credit limit.

In an embodiment looking up a credit limit associated with the payment card comprises accessing a portal or web service provided by the payment card information server.

The method may further comprise updating the credit limit on the payment card information server and/or sending transaction data corresponding to the transaction to the payment card information server.

In an embodiment the transaction amount is in a first currency and the credit limit associated with the payment card is in a second currency, and comparing the transaction amount with the credit limit comprises converting the transaction amount into the second currency. The method may further comprise sending an indication of an exchange rate between the first currency and the second currency to the payment card information server.

The payment card information server may store an authorized date range for use of the payment card in the first territory and the method may further comprise looking up the authorized date range and comparing a current date or date associated with the transaction with the authorized date range for use of the payment card in the first territory. The transaction authorization response may be further based on a result the comparison of the current date or date associated with the transaction with the authorized date range for use of the payment card in the first territory.

According to a third aspect of the present invention there is provided an apparatus for processing an authorization request for a transaction in a first territory associated with a payment card issued in a second territory. The apparatus comprises: a computer processor and a data storage device, the data storage device having an identification module; and a routing module comprising non-transitory instructions operative by the processor to: receive a transaction authorization request, the transaction authorization request comprising an indication of a payment card identifier of a payment card associated with the transaction; determine, using the payment card identifier, a local nominated issuer, the local nominated issuer being an issuing authority within the first territory authorized to process authorization requests associated with the payment card; route the transaction authorization request to a server of the local nominated issuer; and receive a transaction authorization response from the server of the local nominated issuer.

According to a fourth aspect of the present invention there is provided an apparatus for processing an authorization request for a transaction in a first territory associated with a payment card issued in a second territory. The apparatus comprises: a computer processor and a data storage device, the data storage device having a look up module; and an authorization module comprising non-transitory instructions operative by the processor to: receive, a transaction authorization request, the transaction authorization request comprising an indication of a payment card identifier of a payment card associated with the transaction and a transaction amount associated with the transaction; look up a credit limit associated with the payment card on a payment card information server; compare the transaction amount with the credit limit; and generate a transaction authorization response based on a result of comparing the transaction amount with the credit limit.

According to a yet further aspect, there is provided a non-transitory computer-readable medium. The computer-readable medium has stored thereon program instructions for causing at least one processor to perform operations of a method disclosed above.

### BRIEF DESCRIPTION OF THE DRAWINGS

Embodiments of the invention will now be described for the sake of non-limiting example only, with reference to the following drawings in which:

FIG. 1 is a block diagram showing a system for authorizing transactions according to an embodiment of the present invention;

FIG. 2 is a block diagram showing a data processing system for authorizing transactions according to an embodiment of the present invention;

FIG. 3 is a block diagram showing a technical architecture of a payment network server according to an embodiment of the present invention;

FIG. 4 is a block diagram showing a technical architecture of a local nominated issuer server according to an embodiment of the present invention; and

FIG. 5 is a flowchart showing a method of authorization of a transaction in a first territory associated with a payment card issued in a second territory according to an embodiment of the present invention.

### DETAILED DESCRIPTION

As used herein, the term “payment card” refers to any suitable cashless payment device, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC-enabled devices, and/or computers. Each type of payment card can be used as a method of payment for performing a transaction.

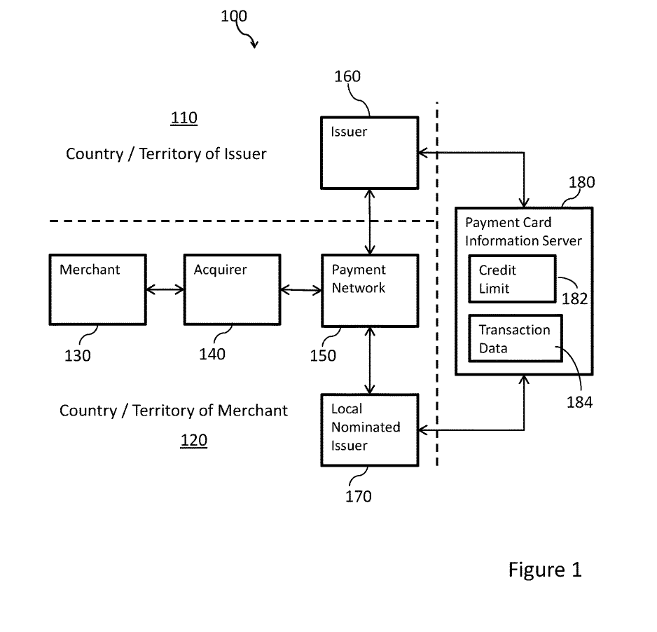

FIG. 1 is a block diagram showing a system for authorizing transactions according to an embodiment of the present invention. The system 100 allows transactions carried out in a first country 120 using a payment card issued in a second country 110 to be authorized in the first country 120.

As shown in FIG. 1, a card issuer 160 is located in a country/territory of issuer 110, in the following description this is referred to as the second territory 110. A merchant 130 at which a transaction takes place is located in a different territory, the country/territory of merchant 120, in the following description this is referred to as the first territory 120.

When a transaction is processed, the merchant 130 communicates with an acquirer 140 in order to authorize the transaction. The acquirer 140 routes the authorization request to a payment network 150. As shown in FIG. 1, the merchant 130, the acquirer 140 and the payment network 150 are all located in the first territory 120.

As described above, the issuer 160 of the payment card used for the transaction is located in a second country 110. In embodiments of the present invention, instead of routing the authorization request to the issuer 160 in the second territory 110, the payment network 150 routes the authorization request to a local nominated issuer 170 in the first territory. The local nominated issuer 170 accesses a payment card information server 180 which stores credit limit information 182 for the payment card. Using the credit limit information 182 stored on the payment card information server 182, the local nominated issuer 170 authorizes the transaction. Once the transaction has been authorized, the local nominated issuer 170 may update the credit limit information 182 stored on the payment card information server 180. Additionally, the local nominated issuer 170 data indicating the transaction as transaction data 184 on the payment card information server 180.

The payment card information server 180 may be located in the first territory 120, the second territory 110, or in a third territory. The payment card information server 180 may provide the credit limit information 182 as a web service or portal which can be accessed and updated by local nominated issuers in various countries.

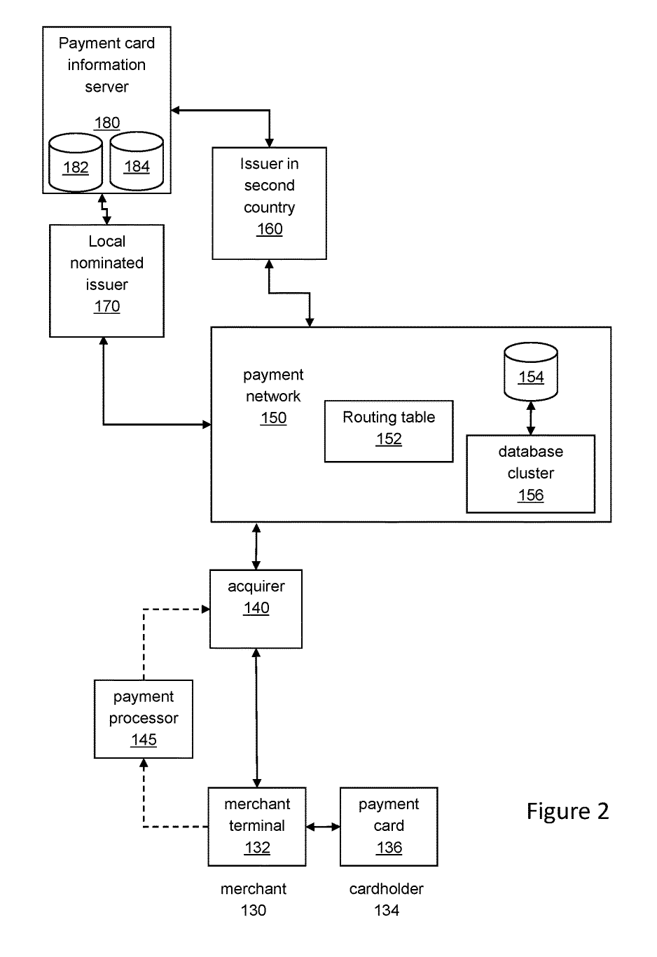

FIG. 2 is a block diagram showing a data processing system for authorizing transactions according to an embodiment of the present invention. As shown in FIG. 2, the payment network 150 acts as an intermediary during a transaction being made by a cardholder 134 using a payment card 136 at a merchant terminal 132 of a merchant 130. In particular, the cardholder 134 may present the payment card 136 to merchant terminal 132 of merchant 130 as payment for goods or services. The merchant terminal 132 may be a point of sale (POS) device such as a magnetic strip reader, chip reader or contactless payment terminal, or a website having online e-commerce capabilities, for example. A merchant 130 may operate one or a plurality of merchant terminals 132. The merchant terminal 132 communicates with an acquirer computer system 140 of a bank or other institution with which the merchant 130 has an established account, in order to request authorisation for the amount of the transaction (sometimes referred to as ticket size) from the acquirer system 160 In some embodiments, if the merchant 130 does not have an account with the acquirer 140, the merchant terminal 132 can be configured to communicate with a third-party payment processor 145 which is authorised by acquirer 140 to perform transaction processing on its behalf, and which does have an account with the acquirer entity.

The acquirer system 140 routes the transaction authorisation request from the merchant terminal 132 to computer systems of the payment network 150. As described above in relation to FIG. 1, in embodiments of the present invention relate to the authorization of payments when the payment card 136 is issued by an issuer in a second territory.

The transaction authorisation request is then routed by payment network 150 to computer systems of the appropriate issuer institution. The payment network 150 determines the appropriate issuer institution based on information contained in the transaction authorisation request, for example the identifier of the payment card 136 using a routing table 152. The routing table 152 may include indications of payment cards which have been registered for use with the local nominated issuer 170. Thus, if the payment card 136 has been registered for use with the local nominated issuer 170, the payment network 150 routes the authorization request to the local nominated issuer 170 according to the routing table 152. However, if the payment card 136 has not been registered for use with the local nominated issuer 170, then the authorization request is routed to the issuer 160 in the second country.

If the authorization request is routed to the local nominated issuer 170, the computer systems of the local nominated issuer 170 analyse the authorization request and access the credit limit data 182 stored on the payment card information server 180 to determine whether to authorize the transaction and generates an authorization response message. The authorization response message is transmitted from the local nominated issuer 170 to the payment network 150, which then routes the authorisation response message to the acquirer system 140.

If the authorization request is routed to the issuer 160 in the second country, the computer systems of the issuer 160 in the second country would analyse the authorisation request to determine the account number submitted by the payment card 136, and based on the account number, determine whether the account is in good standing and whether the transaction amount is covered by the cardholder's account balance or available credit. Then an authorization response message is generated. The authorization response message is transmitted from the issuer 150 in the second country to the payment network 150, which then routes the authorisation response message to the acquirer system 140.

The acquirer system 140, in turn, sends the authorisation response message to the merchant terminal 132. If the authorisation response message indicates that the transaction is approved, then the account of the merchant 130 (or of the payment processor 145 if appropriate) is credited by the amount of the transaction.

During each authorisation request as described in the previous paragraphs, the payment network 150 stores transaction information in a transactions database 154 accessible via a database cluster 156. The database cluster 156 may comprise one or more physical servers. In some embodiments, the transactions database 154 may be distributed over multiple devices which are in communication with one another over a communications network such as a local-area or wide-area network.

The transaction data may comprise a plurality of fields, including acquirer identifier/card accepter identifier (the combination of which uniquely defines the merchant); merchant category code (also known as card acceptor business code), that is, an indication of the type of business the merchant is involved in (for example, a gas station); the transaction environment or method being used to conduct the transaction; product specific data such as SKU line item data; the transaction type; card identifier (e.g., card number); time and date; location (full address and/or GPS data); transaction amount (also referred to herein as ticket size); terminal identifier (e.g., merchant terminal identifier or ATM identifier); and response code (also referred to herein as authorization code). Other fields may be present in each transaction record.

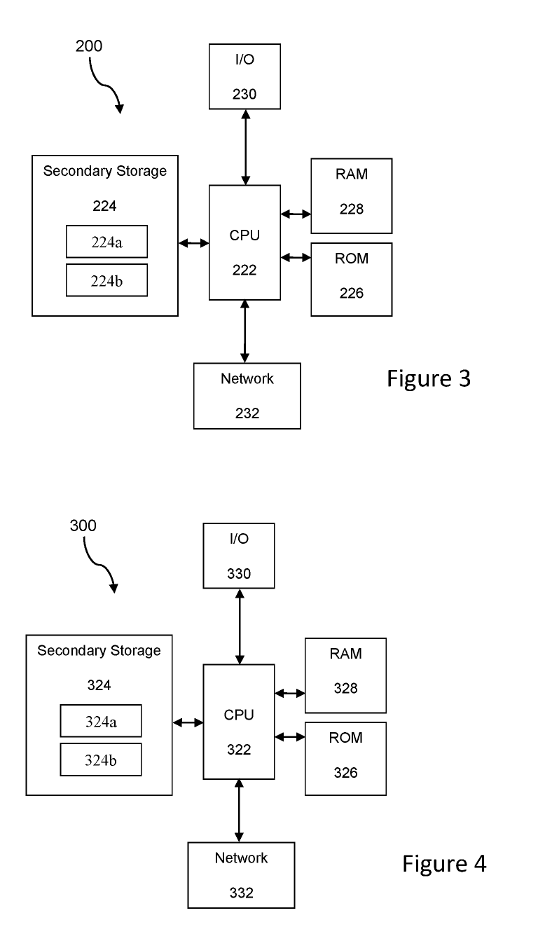

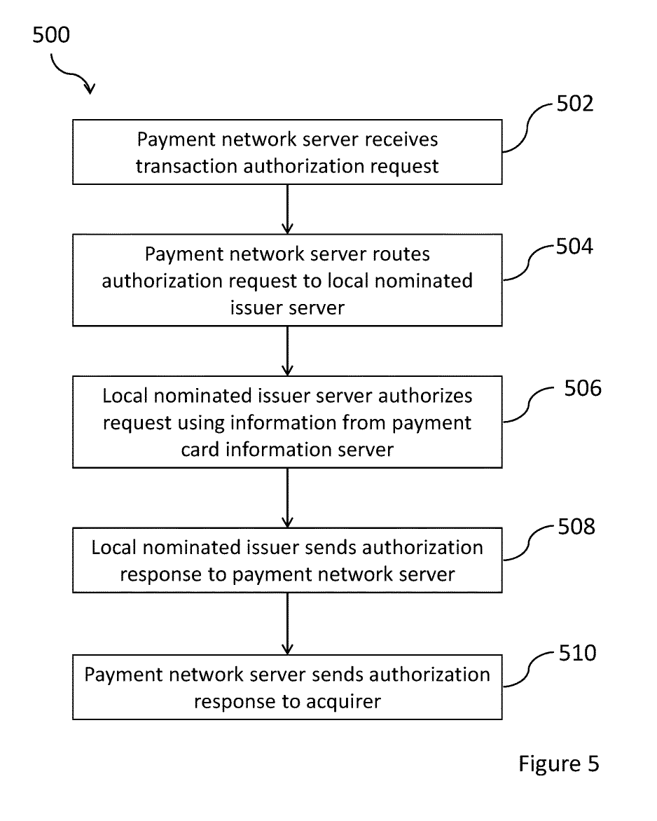

FIG. 3 is a block diagram showing a technical architecture 200 of the payment network server 150 for performing an exemplary method 500 which is described below with reference to FIG. 5. Typically, the method 500 is implemented by a number of computers each having a data-processing unit. The block diagrams as shown FIGS. 3 and 4 illustrate technical architectures 200 and 300 of computers which are suitable for implementing one or more embodiments herein.

The technical architecture 200 includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture 220 may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution. In this embodiment, the secondary storage 224 has an identification module 224a and a routing module 224b comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

It is understood that by programming and/or loading executable instructions onto the technical architecture 200, at least one of the CPU 222, the RAM 228, and the ROM 226 are changed, transforming the technical architecture 200 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

FIG. 4 is a block diagram showing a technical architecture 300 of the local nominated issuer server 170 for performing an exemplary method 500 which is described below with reference to FIG. 5.

The technical architecture 300 includes a processor 322 (which may be referred to as a central processor unit or CPU) that is in communication with memory devices including secondary storage 324 (such as disk drives), read only memory (ROM) 326, random access memory (RAM) 328. The processor 322 may be implemented as one or more CPU chips. The technical architecture 320 may further comprise input/output (I/O) devices 330, and network connectivity devices 332.

The secondary storage 324 is typically comprised of one or more disk drives or tape drives and is used for non-volatile storage of data and as an over-flow data storage device if RAM 328 is not large enough to hold all working data. Secondary storage 324 may be used to store programs which are loaded into RAM 328 when such programs are selected for execution. In this embodiment, the secondary storage 324 has a look-up module 324a, and an authorization module 324b comprising non-transitory instructions operative by the processor 322 to perform various operations of the method of the present disclosure. The ROM 326 is used to store instructions and perhaps data which are read during program execution. The secondary storage 324, the RAM 328, and/or the ROM 326 may be referred to in some contexts as computer readable storage media and/or non-transitory computer readable media.

I/O devices 330 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 332 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 332 may enable the processor 322 to communicate with the Internet or one or more intranets. With such a network connection, it is contemplated that the processor 322 might receive information from the network, or might output information to the network in the course of performing the above-described method operations. Such information, which is often represented as a sequence of instructions to be executed using processor 322, may be received from and outputted to the network, for example, in the form of a computer data signal embodied in a carrier wave.

The processor 322 executes instructions, codes, computer programs, scripts which it accesses from hard disk, floppy disk, optical disk (these various disk based systems may all be considered secondary storage 324), flash drive, ROM 326, RAM 328, or the network connectivity devices 332. While only one processor 322 is shown, multiple processors may be present. Thus, while instructions may be discussed as executed by a processor, the instructions may be executed simultaneously, serially, or otherwise executed by one or multiple processors.

It is understood that by programming and/or loading executable instructions onto the technical architecture 300, at least one of the CPU 322, the RAM 328, and the ROM 326 are changed, transforming the technical architecture 300 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Although the technical architectures 200 and 300 are described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architectures 200 and 300 to provide the functionality of a number of servers that is not directly bound to the number of computers in the technical architectures 200 and 300. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

Various operations of the exemplary method 500 will now be described with reference to FIG. 5 in respect of authorization of a transaction in a first territory associated with a payment card issued in a second territory. It should be noted that enumeration of operations is for purposes of clarity and that the operations need not be performed in the order implied by the enumeration.

In step 502, the payment network server 150 receives a transaction authorization request from the acquirer 140. The transaction authorization request comprises an identifier of a payment card and a transaction amount corresponding to a transaction at the merchant 130. As discussed above, embodiments of the present invention relate to transactions carried out in the country or territory of the merchant which is referred to as the first territory 120 using a payment card issued in the country or territory of the issuer which is referred to as the second territory.

In step 504, the payment network server 150 identifies that transactions corresponding to the payment card can be authorized by the local nominated issuer 170. Step 504 may involve the payment network server looking up the payment card using a payment card identifier in a routing table. The routing table may specify payment cards which may be authorized by the local nominated issuer 170. It is noted here that authorization requests corresponding to payment cards issued by the issuer 160 from the second territory 110 would normally be routed to the issuer 160 in the second territory 110. Once the payment network server 504 has identified that the transaction can be authorized by the local nominated issuer 170, the payment network server 150 routes the transaction authorization request to the local nominated issuer server 170.

In step 506, the local nominated issuer authorizes the transaction authorization request using information from the payment card information server 180. Step 506 may involve the local nominated issuer server 170 accessing a portal or web service implemented by the payment card information server 180 to obtain the credit limit 182 for the payment card. The credit limit 182 may be stored in the payment card information server 180 in the currency of the second territory or the currency of another territory. Thus, step 506 may involve the local nominated issuer server 170 converting the credit limit into the currency of the first territory 120. In step 506, the local nominated issuer server 170 compares the credit limit 182 with the transaction amount and authorizes the transaction if the transaction amount is less than the credit limit 182.

In some embodiments, the payment card information server 180 may store an indication of a range of dates that the payment card has been authorized for use in the first territory. In such embodiments, step 506 may comprise the local nominated issuer server 170 comparing the current date or a date associated with the transaction with the range of dates.

In some embodiments, once the local nominated issuer server 170 has authorized the transaction request, the local nominated issuer server 170 updates the credit limit 182 by subtracting the transaction amount and storing the new value as the credit limit 182. The local nominated issuer 170 may also save details of the transaction in as transaction data 184 on the payment card information server 180. This transaction information may include information such as an identifier/card accepter identifier (the combination of which uniquely defines the merchant); merchant category code (also known as card acceptor business code), that is, an indication of the type of business the merchant is involved in (for example, a gas station); the transaction environment or method being used to conduct the transaction; product specific data such as SKU line item data; the transaction type; card identifier (e.g., card number); time and date; location (full address and/or GPS data); transaction amount (also referred to herein as ticket size); terminal identifier (e.g., merchant terminal identifier or ATM identifier); and response code (also referred to herein as authorization code). The transaction data 184 may also include details of the exchange rate between the currency of the first country and the currency of the second currency at the time the transaction was carried out.

In step 508, the local nominated issuer server 170 sends a transaction authorization response to the payment network server 150.

In step 510, the payment network server 150 sends the transaction authorization response to the acquirer 140. The transaction authorization response is then sent to the merchant 130 by the acquirer.

As described above, embodiments of the present invention allow a cardholder from a second territory to carryout transactions in a first territory without the need for the issuer in the second territory to be involved in the authorization.

In order to use the feature described above, a cardholder may contact the issuer in the second territory and request that a cross border roaming facility is initiated. During this process, the cardholder may specify one or more countries/territories than they are planning to visit and the dates that they intend to be in those countries/territories. This information is then stored on the payment card information server 180 and routing tables of payment network servers in the relevant territories are updated to indicate that the payment card of the cardholder may be authorized by a local nominated issuer in those territories.

Then when the cardholder carries out transactions in those territories, the authorization of the transactions is carried out as described above. It is noted that transaction data 184 for the transactions is stored on the payment card information server 180, thus the issuer 160 may access the transaction data 184 to generate a bill for the cardholder.

Whilst the foregoing description has described exemplary embodiments, it will be understood by those skilled in the art that many variations of the embodiment can be made within the scope and spirit of the present invention.

1. A computer implemented method of processing an authorization request for a transaction in a first territory associated with a payment card issued in a second territory, the method comprising
receiving, at a server of a payment network, a transaction authorization request, the transaction authorization request comprising an indication of a payment card identifier of a payment card associated with the transaction;
determining, using the payment card identifier, a local nominated issuer, the local nominated issuer being an issuing authority within the first territory authorized to process authorization requests associated with the payment card;
routing the transaction authorization request to a server of the local nominated issuer; and
receiving a transaction authorization response from the server of the local nominated issuer.

2. A method according to claim 1, wherein determining using the payment card identifier, a local nominated issuer comprises identifying an entry in a routing table corresponding to the payment card identifier.

3. A computer implemented method of processing an authorization request for a transaction in a first territory associated with a payment card issued in a second territory, the method comprising
receiving, at a server of a local nominated issuer, a transaction authorization request, the local nominated issuer being an issuing authority within the first territory authorized to process authorization requests associated with the payment card, the transaction authorization request comprising an indication of a payment card identifier of a payment card associated with the transaction and a transaction amount associated with the transaction;
looking up a credit limit associated with the payment card on a payment card information server;
comparing the transaction amount with the credit limit; and
generating a transaction authorization response based on a result of comparing the transaction amount with the credit limit.

4. A method according to claim 3, wherein looking up a credit limit associated with the payment card comprises accessing a portal or web service provided by the payment card information server.

5. A method according to claim 3, further comprising updating the credit limit on the payment card information server.

6. A method according to claim 3, further comprising sending transaction data corresponding to the transaction to the payment card information server.

7. A method according to claim 3, wherein the transaction amount is in a first currency and the credit limit associated with the payment card is in a second currency, and comparing the transaction amount with the credit limit comprises converting the transaction amount into the second currency.

8. A method according to claim 7, further comprising sending an indication of an exchange rate between the first currency and the second currency to the payment card information server.

9. A method according to claim 3, further comprising looking up an authorized date range for use of the payment card in the first territory on the payment card information server and comparing a current date or date associated with the transaction with the authorized date range for use of the payment card in the first territory and wherein the transaction authorization response is further based on a result the comparison of the current date or date associated with the transaction with the authorized date range for use of the payment card in the first territory.

10. A non-transitory computer readable medium having stored therein instructions that when executed cause a computer to perform a method of authorizing request for a transaction in a first territory associated with a payment card in a second territory, the method comprising:
receiving, at a server of a payment network, a transaction authorization request, the transaction authorization request comprising an indication of a payment card identifier of a payment card associated with the transaction;
determining, using the payment cad identifier, a local nominated issuer, the local nominated issuer being an issuing authority within the first territory authorized to process authorization requests associated with the payment card;
routing the transaction authorization request to a server of the local nominated user; and
receiving a transaction authorization response from the server of the local nominated user.

11. An apparatus for processing an authorization request for a transaction in a first territory associated with a payment card issued in a second territory, the apparatus comprising:
a computer processor and a data storage device, the data storage device having an identification module; and a routing module comprising non-transitory instructions operative by the processor to:
receive a transaction authorization request, the transaction authorization request comprising an indication of a payment card identifier of a payment card associated with the transaction;
determine, using the payment card identifier, a local nominated issuer, the local nominated issuer being an issuing authority within the first territory authorized to process authorization requests associated with the payment card;
route the transaction authorization request to a server of the local nominated issuer; and
receive a transaction authorization response from the server of the local nominated issuer.

12. An apparatus according to claim 11, further comprising storage for a routing table and wherein the routing module further comprises non-transitory instructions operative by the processor to identify an entry in a routing table corresponding to the payment card identifier.

13. An apparatus for processing an authorization request for a transaction in a first territory associated with a payment card issued in a second territory, the apparatus comprising:
a computer processor and a data storage device, the data storage device having a look up module; and an authorization module comprising non-transitory instructions operative by the processor to:
receive, a transaction authorization request, the transaction authorization request comprising an indication of a payment card identifier of a payment card associated with the transaction and a transaction amount associated with the transaction;
look up a credit limit associated with the payment card on a payment card information server;
compare the transaction amount with the credit limit; and
generate a transaction authorization response based on a result of comparing the transaction amount with the credit limit.

14. An apparatus according to claim 13, wherein the look up module further comprises non-transitory instructions operative by the processor to: access a portal or web service provided by the payment card information server.

15. An apparatus according to claim 13, wherein the authorization module further comprises non-transitory instructions operative by the processor to: update the credit limit on the payment card information server.

16. An apparatus according to claim 13, being further operable to send transaction data corresponding to the transaction to the payment card information server.

17. An apparatus according to claim 13, wherein the transaction amount is in a first currency and the credit limit associated with the payment card is in a second currency, and the authorization module further comprises non-transitory instructions operative by the processor to: compare the transaction amount with the credit limit comprises converting the transaction amount into the second currency.

18. An apparatus according to claim 17, wherein the authorization module further comprises non-transitory instructions operative by the processor to: send an indication of an exchange rate between the first currency and the second currency to the payment card information server.

19. An apparatus according to claim 13, wherein the look up module further comprises non-transitory instructions operative by the processor to: look up an authorized date range for use of the payment card in the first territory on the payment card information server and comparing a current date or date associated with the transaction with the authorized date range for use of the payment card in the first territory and wherein the transaction authorization response is further based on a result the comparison of the current date or date associated with the transaction with the authorized date range for use of the payment card in the first territory.
